(19) United States
(12) Patent Application Publication
(10) Pub. No.: US 2003/0037319 A1
(43) Pub. Date: Feb. 20, 2003

(54) Method and apparatus for partitioning and placement for a cycle-based simulation system

(76) Inventor: Ankur Narang, New Delhi (IN)

Correspondence Address: ROSENTHAL & OSHA L.L.P., 1221 MCKINNEY AVENUE, SUITE 2800, HOUSTON, TX, 77010, US

(21) Appl. No.: 10/112,508

(22) Filed: Mar. 28, 2002

Related U.S. Application Data
(60) Provisional application No. 60/313,762, filed on Aug. 20, 2001.

(51) Int. Cl. G06F 9/45

(52) U.S. Cl. 717/144; 717/149

(57) ABSTRACT

A method for partitioning execution processor code in a cycle-based system involves generating an intermediate form data flow graph during compilation of execution processor code, creating a plurality of nodes from the intermediate form data flow graph, merging at least two of the plurality of nodes to form a supernode, and assigning the supernode to a processor array.

### CROSS-REFERENCE TO RELATED APPLICATIONS

This application claims benefit of U.S. Provisional Application Serial No. 60/313,762, filed Aug. 20, 2001, entitled “Phasers-Compiler Related Inventions,” in the names of Liang T. Chen, Jeffrey Broughton, Derek Pappas, William Lam, Thomas M. McWilliams, Ihao Chen, Ankur Narang, Jeffrey Rubin, Earl T. Cohen, Michael Parkin, Ashley Saulsbury, and David R. Emberson.

### BACKGROUND OF INVENTION

Massively parallel processing (MPP) environments are computer environments that operate using a massive number of processors. It is typical for an MPP environment to use tens of thousands of processors. Each processor in such an environment is able to execute computer instructions at the same time which results in a very powerful system since many calculations take place simultaneously. Such an environment is useful for a wide variety of purposes. One such purpose is for the software simulation of a hardware design.

Large logic simulations are frequently executed on parallel or massively parallel computing systems. For example, parallel computing systems may be specifically designed parallel processing systems or a collection, referred to as a “farm,” of connected general purpose processing systems. FIG. 1 shows a block diagram of a typical parallel computing system (100) used to simulate an HDL logic design. Multiple processor arrays (112a, 112b, 112n) are available to simulate the HDL logic design. A host computer (116), with associated data store (117), controls a simulation of the logic design that executes on one or more of the processor arrays (112a, 112b, 112n) through an interconnect switch (118). The processor arrays (112a, 112b, 112n) may be a collection of processing elements or multiple general purpose processors. The interconnect switch (118) may be a specifically designed interconnect or a general purpose communication system, for example, an Ethernet network.

A general purpose computer (120) with a human interface (122), such as a graphical user interface (GUI) or a command line interface, together with the host computer (116) support common functions of a simulation environment. These functions typically include an interactive display, modification of the simulation state, setting of execution breakpoints based on simulation times and states, use of test vectors files and trace files, use of HDL modules that execute on the host computer and are called from the processor arrays, check pointing and restoration of running simulations, the generation of value change dump files compatible with waveform analysis tools, and single execution of a clock cycle.

The software simulation of a hardware logic design involves using a computer program to cause a computer system to behave in a manner that is analogous to the behavior of a physical hardware device. Software simulation of a hardware logic design is particularly beneficial because the actual manufacturing of a hardware device can be expensive. Software simulation allows the user to determine the efficacy of a hardware design. Software simulation of a hardware logic design is well-suited for use in an MPP environment because hardware normally performs many activities simultaneously.

In an MPP environment, an individual logic design modeling a physical hardware device can be simulated on a potentially large number of parallel processing arrays. Before the logic design is able to execute, the design is partitioned into many small parts, one part per processor array. Once partitioned, each part is scheduled for a corresponding processor array or multiple processor arrays. Scheduling involves both timing and resource availability issues of the processor array executing a node (i.e., a gate or a HDL statement).

The ultimate goal of a partitioning solution is to obtain the minimum runtime of the logic design. According to current schemes, two criteria are used to measure the quality of a partitioning solution: the degree of parallelism of the parts in the partition and the amount of inter-processor communication. The degree of parallelism is the number of parts in a partition that can be executed simultaneously. The degree of parallelism alone, however, is not enough to guarantee a fast overall simulation time of the circuit because communication cost limits the contribution of parallelism to the overall simulation time. The inter-processor communication results in a communication cost (sometimes referred to as overhead) between the processor arrays. The ratio of computation time and communication time is used as a quantitative measure, i.e., the time the processor array spends on computation over the time the processor array spends on communication).

### SUMMARY OF INVENTION

In general, in one aspect, the invention relates to a method for partitioning execution processor code in a cycle-based system. The method comprises generating an intermediate form data flow graph during compilation of execution processor code, creating a plurality of nodes from the intermediate form data flow graph, merging at least two of the plurality of nodes to form a supernode, and assigning the supernode to a processor array.

In general, in one aspect, the invention relates to a method for partitioning execution processor code in a cycle-based system. The method comprises generating an intermediate form data flow graph during compilation of execution processor code, creating a plurality of nodes from the intermediate form data flow graph, merging at least two of the plurality of nodes to form a supernode, assigning the supernode to a processor array, arranging the plurality of nodes within the processor array to minimize a communication cost between a plurality of supernodes, visiting each member of the plurality of nodes and each member of the plurality of supernodes in random order and moving the node to a different partition to minimize the communication cost, and mapping the plurality of nodes within the supernode to the processor array.

In general, in one aspect, the invention relates to a computer system to partition execution processor code in a cycle-based system. The system comprises a processor, a memory, and software instructions stored in the memory for enabling the computer system under control of the processor. The software instructions perform generating an intermediate form data flow graph during compilation of execution processor code, creating a plurality of nodes from the intermediate form data flow graph, merging at least two of the plurality of nodes to form a supernode, and assigning the supernode to a processor array.

In general, in one aspect, the invention relates to a computer system to partition execution processor code in a cycle-based system. The system comprises a processor, a memory, and software instructions stored in the memory for enabling the computer system under control of the processor. The software instructions perform generating an intermediate form data flow graph during compilation of execution processor code, creating a plurality of nodes from the intermediate form data flow graph, merging at least two of the plurality of nodes to form a supernode, assigning the supernode to a processor array, arranging the plurality of nodes within the processor array to minimize a communication cost between a plurality of supernodes, and mapping the plurality of nodes within the supernode to the processor array.

In general, in one aspect, the invention relates to an apparatus for partitioning execution processor code in a cycle-based system. The apparatus comprises means for generating an intermediate form data flow graph during compilation of execution processor code, means for creating a plurality of nodes from the intermediate form data flow graph, means for merging at least two of the plurality of nodes to form a supernode, and means for assigning the supernode to a processor array.

Other aspects and advantages of the invention will be apparent from the following description and the appended claims.

### BRIEF DESCRIPTION OF DRAWINGS

FIG. 1 shows a typical parallel computer system.

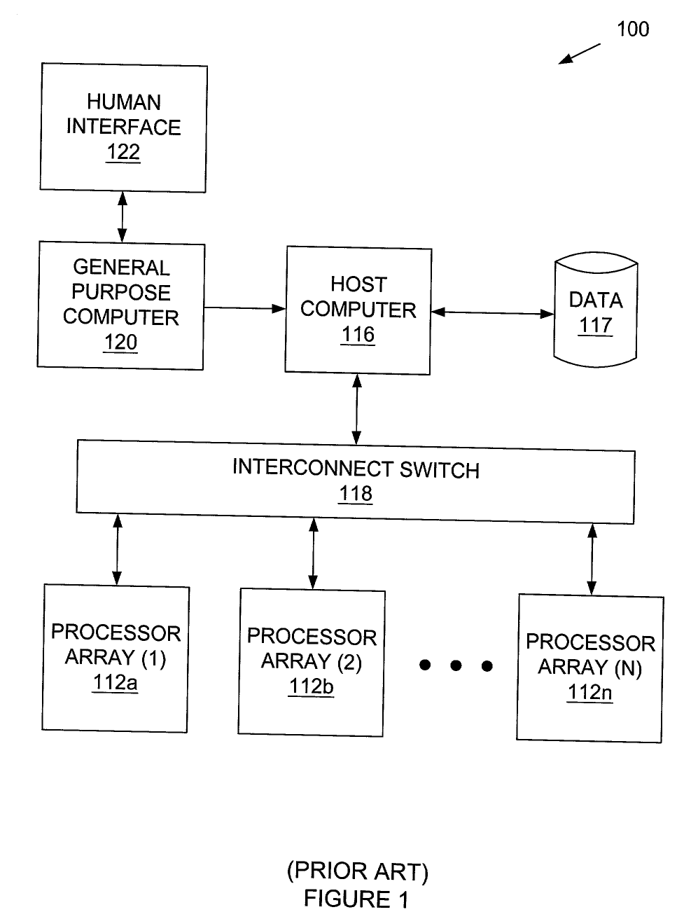

FIG. 2 shows a parallel computer system in accordance with one embodiment of the present invention.

FIG. 3 shows a general purpose computer system.

FIG. 4A shows a flow diagram of multi-level parallelyzer algorithm in accordance with one embodiment of the present invention.

FIG. 4B shows a diagram of the coarsening of IFnodes into superNodes within the coarsening phase of the partitioning solution in accordance with one embodiment of the present invention.

FIG. 5 shows a flowchart of a partitioning solution in accordance with one embodiment of the present invention.

### DETAILED DESCRIPTION

Specific embodiments of the invention will now be described in detail with reference to the accompanying figures. Like elements in the various figures are denoted by like reference numerals for consistency.

The present invention involves a method and apparatus for partitioning a logic design for a cycle-based simulation system. In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

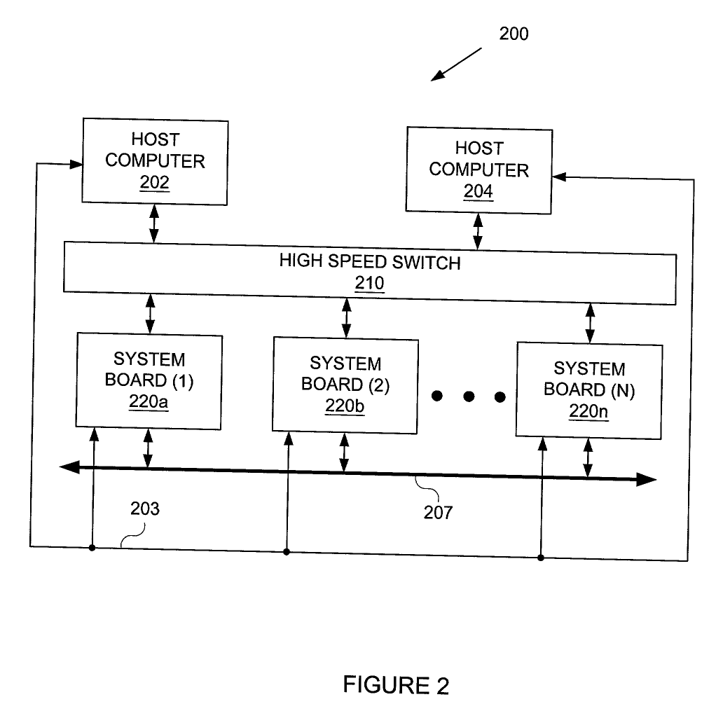

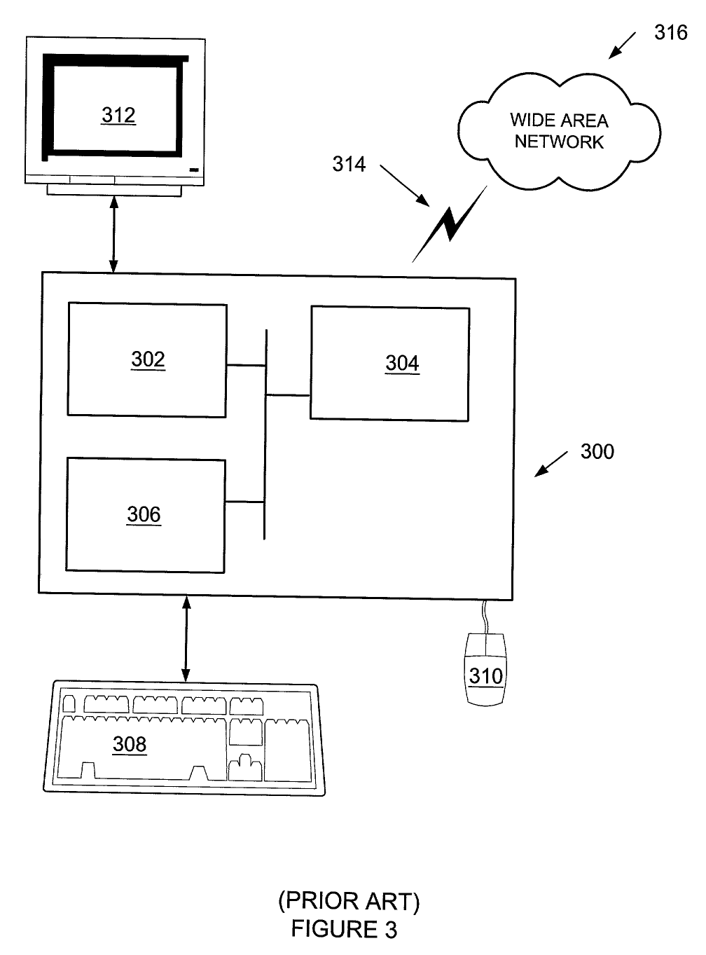

A computer execution environment and a class of simulation systems, e.g., multiple instruction, multiple data (MIMD), used with one or more embodiments of the invention is described in FIGS. 2-3. In an embodiment of the present invention, the computer execution environment may use execution processors to execute execution processor code on a general purpose computer, such as a SPARC™ workstation produced by Sun Microsystems, Inc., or specialized hardware for performing cycle-based computations, e.g., a Phaser system.

The system on which a compiled hardware design logic may be executed in one or embodiments of the invention is a massively parallel, cycle-based computing system. The system uses an array of execution processors arranged to perform cycle-based computations. One example of cycle-based computation is simulation of a cycle-based design written in a computer readable language, such as HDL (e.g., Verilog, etc.), or a high-level language (e.g., Occam, Modula, C, etc.).

FIG. 2 shows exemplary elements of a massively parallel, cycle-based computing system (200), in accordance with one or more embodiments of the present invention. Cycle-based computation, such as a logic simulation on the system (200), involves one or more host computers (202, 204) managing the logic simulation(s) executing on one or more system boards (220a, 220b, 220n). Each system board contains one or more Application Specific Integrated Circuits (ASIC). Each ASIC contains multiple execution processors, e.g., an 8-processor sub-cluster having a sub-cluster crossbar that connects to eight execution processors. The execution processors are capable of executing custom instructions that enable cycle-based computations, such as specific logic operations (e.g., four input, one output Boolean functions, etc.).

The host computers (202, 204) may communicate with the system boards (220a, 220b, 220n) using one of several pathways. The host computers (202, 204) include interface hardware and software as needed to manage a logic simulation. A high speed switch (210) connects the host computers (202, 204) to the system boards (220a, 220b, 220n). The high speed switch (210) is used for loading and retrieval of state information from the execution processors located on ASICs on each of the system boards (220a, 220b, 220n). The connection between the host computers (202, 204) and system boards (220a, 220b, 220n) also includes an Ethernet connection (203). The Ethernet connection (203) is used for service functions, such as loading a program and debugging. The system also includes a backplane (207). The backplane (207) allows the ASICs on one system board to communicate with the ASICs of another system board (220a, 220b, 220n) without having to communicate with an embedded controller located on each system board. Additional system boards may be added to the system by connecting more system boards to the backplane (207).

In one or more embodiments of the present invention, the computer execution environment to perform partitioning of a logic design in a cycle-based, logic simulation system may be a general purpose computer, such as a SPARC™ workstation produced by Sun Microsystems, Inc. For example, as shown in FIG. 3, a typical general purpose computer (300) has a processor (302), associated memory (304), a storage device (306), and numerous other elements and functionalities typical to today's computers (not shown). The computer (300) has associated therewith input means such as a keyboard (308) and a mouse (310), although in an accessible environment these input means may take other forms. The computer (300) is also associated with an output device such as a display device (312), which may also take a different form in an accessible environment. The computer (300) is connected via a connection means (314) to a Wide Area Network (WAN) (316). The computer (300) may be interface with a massively parallel, cycle-based computing system described above and as shown in FIG. 2.

The computer systems described above are for purposes of example only. Embodiments of the invention may be implemented in any type of computer system or programming or processing environment.

The goal of partitioning is to assign each of the simulation instructions and variables of the execution processor code to a unique processor array in such a way that: (1) the total number of message passes is minimized; (2) the total latency of all operations and messages on the data interconnect paths and particularly the critical (longest) computational path through the design is minimized; and (3) resource and capacity constraints within any processor array or routing processor are not exceeded.

The task of a partitioner, as part of the partitioning solution, is to take as input an intermediate form data flow graph (referred to herein as “Ifgraph”) generated by the data analysis and optimization modules of the compilation phase and assign each intermediate form node (referred to herein as “Ifnode”) to an execution processor on the hardware. The number of execution processors needed is determined by the partitioner. In an embodiment of the invention, a user can control the utilization of the execution processor through a command line option.

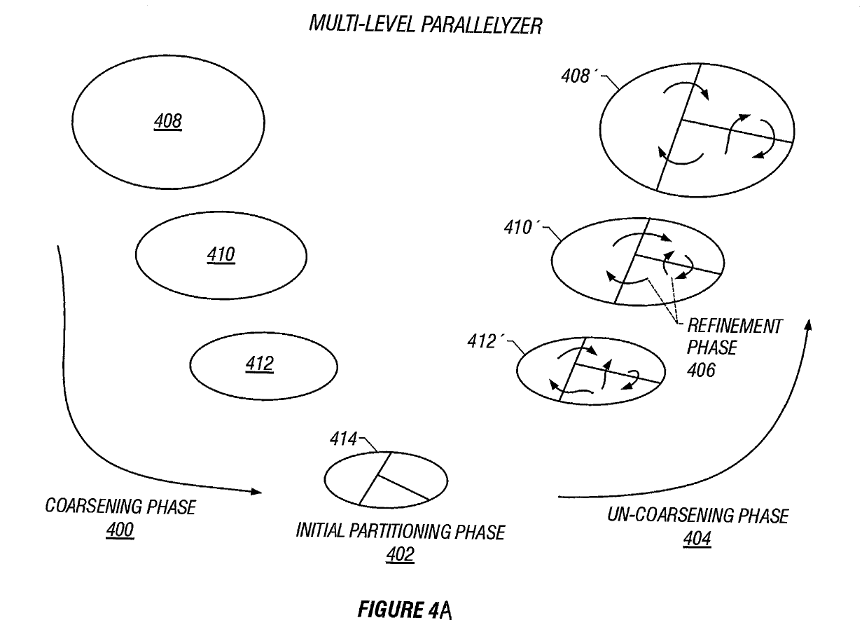

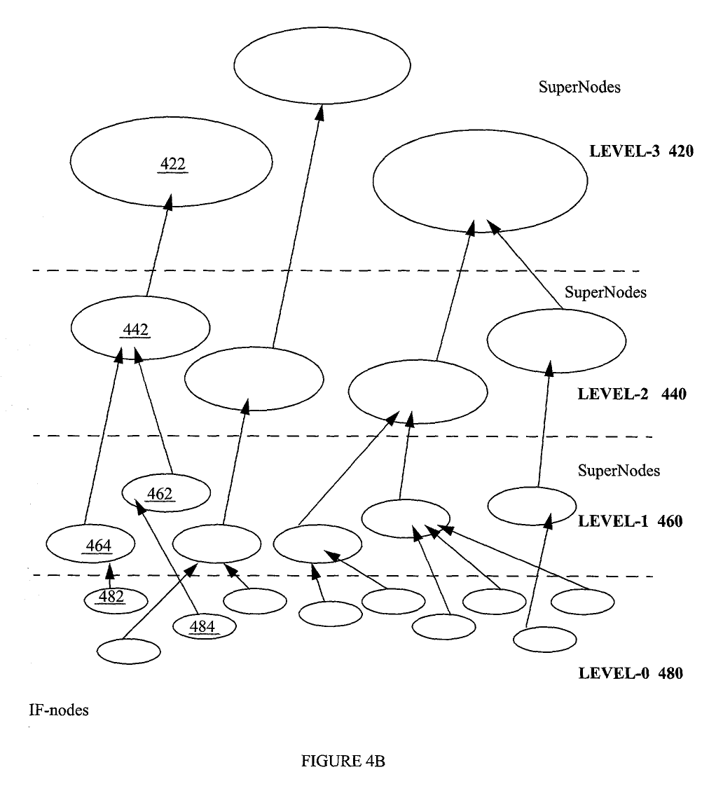

The partitioning solution incorporates a bottom-up, multi-level approach referred to as a multi-level parallelyzer solution. This solution has three main phases: Coarsening, Initial Partitioning, and Uncoarsening and Refinement. FIG. 4A, in one or more embodiments of the invention, shows a flow diagram of the multi-level parallelyzer solution. Each oval represents an IFgraph of IFnodes, each IFgraph is within a different level of the graph hierarchy. The coarsening phase (Step 400) initiates the solution resulting in IFgraph (408) becoming coarser and coarser. The coarsening of IFgraph (408) compresses the information needed to represent IFgraph (408) resulting in the coarser IFgraph (410). Similarly, IFgraph (410) compresses the information needed to represent IFgraph (410) resulting in the coarser IFgraph (412). The coarsest graph (414) is formed from the coarsening of IFgraph (412). In one or more embodiments of the invention, IFgraph (414) is partitioned, using a greedy partitioning technique represented by two line segments within the IFgraph (414), in the initial partioning phase (Step 402). The uncoarsening phase is initiated (Step 404), and the IFgraph (414) is uncoarsened forming IFgraph (412′). IFgraph (412′) “inherits” the partitions established in the initial partitioning phase. Similarly, the IFgraph (412′) is uncoarsened forming IFgraph (410′), where IFgraph (410′) has the partitions established by IFgraph (412′). The IFgraph (408′) is also formed from uncoarsening (410′) and IFgraph (408′) has partitions established by IFgraph (410′). The refinement phase (Step 406) is represented by a series of arrows contained within IFgraph (412′), IFgraph (410′), and IFgraph (408′), indicating improvements in the quality of partitions previously created.

The coarsening phase (Step 400) involves clustering (coarsening) highly-connected IFnodes together and constructing superNodes representing feasible execution processors, subclusters (i.e., a collection of execution processors), ASICs, and system boards. As IFnodes are merged during the coarsening phase, resource limits are obeyed to ensure the generation of a feasible execution processor, subcluster, ASIC, and a system board. Any violations are corrected in a subsequent step. The coarsening phase is also an important component to achieve initial good quality partitioning solution.

FIG. 4B, in one or more embodiments of the invention, shows a diagram of the coarsening of IFnodes into superNodes within the coarsening phase of the partitioning solution. In this particular example, the diagram shows IFnodes inside the IFgraph and the relationship between superNodes at different levels of the data flow graph hierarchy. The diagram shows four levels: level 3 (420), level 2 (440), level 1 (460), and level 0 (480). Only IFnodes are located on level 0 (480). The “coarseness” (i.e., the degree of coarsening) of the nodes (IFnodes or superNodes) descends from level 3 (420) to level 0 (480). The arrows in FIG. 4B are directed toward the parent superNodes. SuperNode (422) is at level 3 (420) and has one child, superNode (442) located at level 2 (440). SuperNode (442) has two children (462, 464), both children (462, 464) are superNodes and are located in level 1 (460). The superNode (462) and superNode (464) both have children (482, 484). Both children (484, 482) are IFnodes and are located at level 0 (480). Various heuristics are used in the coarsening phase to determine, for example in FIG. 4B, the relationships of the nodes (IFnodes or superNodes) between the different levels of the data flow graph hierarchy. In one embodiment of the invention, the heuristics used may include: Heavy Edge Binary Matching, Heavy Edge K-way Matching, Schedule-based Clustering, Random Binary Matching, Random K-way Matching, Critical Subset Hyperedge Coarsening, and Functional Merge. These various heuristics are used in this phase to get lower communication cost, lower schedule length, and higher utilization in the execution processors.

Heavy Edge Matching involves merging two IFnodes that communicate maximally with each other ensuring that after the merge step, the heavy edges in the input graph have been inside the cluster. The term heavy edge refers to an edge with a high communication cost. The communication cost value includes a variety of parameters, but most commonly refers to the number of data flow edges included in an edge, i.e., a superEdge, connecting two superNodes. Other parameters include the amount of data flowing through the superEdge and/or the number of multicasts from IFnodes included in the superEdge. The process of heavy edge matching can be done in a binary fashion where only two IFnodes are merged and also in a k-way fashion where more than two IFnodes are merged until a resulting superNode has been maximally filled or no more edges are left to be absorbed, whichever happens first.

Schedule-based Clustering tries to zero-in the critical path edges in the logic design. The term zero-in refers to absorption of edges within a nextLevel superNode, so that the edge lies on the same processor. If a critical path edge lies between processors, then the message latency is added to the schedule length and leads to higher schedule length. Thus, the schedule-based clustering process tends to reduce the final critical path length of the partitioned and scheduled logic design.

Random matching involves merging IFnodes in a pseudo-random fashion so that the utilization of a processor is maximized. In a scenario where an IFgraph is sparse in data flow edges and if the clustering is done purely on the basis of data flow edges between IFnodes, then the number of processors generated may be significantly high with poor utilization on many processors. So, a pseudo-random approach tries to combine nodes not related by data flow edges. The approach uses partial functional hierarchy information to guide the merge process. A functional clustering approach helps to cluster the IFnodes based on the available design hierarchy information.

Critical Subset Hyperedge Coarsening involves merging the nodes connected by the critical subset of edges in the hyperedges of the input data flow hypergraph. The hyperedge is an accurate representation of a net in logic design with multiple sinks and a single source. A graph containing hyperedges and Ifnodes is referred to as a hypergraph. The hyperedge is one edge with multiple nodes connected to it. One hyperedge may be approximated by multiple “regular” graph-edges, each of which connects the source to one sink. The critical edges within a hyperedge are those graph-edges that are on the critical path. The selection of hyperdges and the subset of edges within the hyperedge is based on the weight and how critical hyperedges are with respect to the schedule.

Functional Merge provides the potential to use design hierarchy information to reduce the communication cost obtained after partitioning. Functional Merge involves merging nodes based on which design sub-block the IFnode belongs to in the input logic design to be partitioned. Based on the assumption that IFnodes within the same design sub-block are merged together in order to achieve less communication cost between clusters, i.e., superNodes, obtained after coarsening. As the coarsening steps progress, the level of the design hierarchy used moves from deep to shallow. This enables higher utilization in the generated feasible execution processor nodes. The relative size of each of the design sub-blocks considered can be balanced to ensure better coarsening.

In the initial partitioning phase (Step 402), superNodes are assigned to processor arrays level by level starting from system boards to ASICs to subclusters to the execution processors. The initial partitioning phase also includes placement optimization to balance the input/output across ASICs for lower congestion in the data interconnect, lower average distance traveled by a message, and/or lower average message latency in the simulation system. The initial partitioning phase uses a greedy approach to construct an initial placement. The initial placement is refined using swap-based operations to meet established quality objectives.

In the uncoarsening (Step 404) and refinement phase (Step 406), a local refinement step at each level of hierarchy within the system boards, ASICs, subclusters, and execution processors may be initiated to get a reduction in communication cost at that level. The IFnodes are moved locally, under resource constraints, to get lower communication costs. The moves should also obey the routing processor memory limits. This process continues until the superNodes are mapped to execution processors.

Finally, the IFnodes get mapped to individual execution processors to which the parent superNode is assigned in the simulation system and the resources consumed by an IFnode are allocated on that execution processor block.

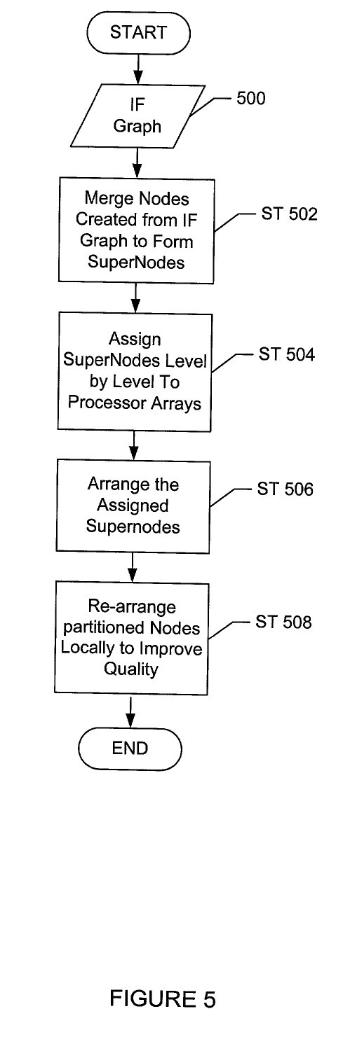

FIG. 5, shows flowchart of a partitioning solution in accordance with one or more embodiments of the present invention described in FIG. 4. A multi-level parallelyzer solution begins with the input of an IFgraph (Step 500). IFnodes created from the IFgraph merge to form superNodes (Step 502). Merging highly connected IFnodes forms superNodes representing feasible execution processors, subclusters, ASICs, and system boards. SuperNodes are assigned level by level to processor arrays (i.e., superNodes are assigned from system boards to ASICs to subclusters to execution processors) (Step 504). The assigned superNodes are arranged according to communication costs, or set partitions (Step 506). The partitioned IFnodes are rearranged locally to improve the quality of the partitioning (Step 508). In both Step 506 and Step 508, arrangements are made to minimize the communication between partitioned IFnodes and superNodes. In one embodiment, a greedy scheme is used to achieve a reduction in communication cost within a level of hardware hierarchy by visiting superNodes in random order and evaluating the gain of a move. Each superNode is checked to determine whether, by moving the IFnode to a different partition, the objective function improves. If such moves exist, the move with the highest gain is selected subject to balance constraints.

Advantages of the present invention may include one or more of the following. Maximal utilization of processor array and interconnect resources is provided, which results in a minimal communication cost, a minimal schedule length, and minimal routing congestion in a MPP environment. Communication cost minimization at all switching points and levels in the data interconnect is provided. Monotonic reduction in the number of messages with increasing distance is provided. Input/output constraints at all switching points and levels in the interconnect are met. Partitioning in a multi-board system is provided. Critical path optimization within the partitioning solution is provided. Providing an interconnect congestion report using the gathered information while partitioning is provided. Those skilled in the art appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for partitioning execution processor code in a cycle-based system comprising:
generating an intermediate form data flow graph during compilation of execution processor code;
creating a plurality of nodes from the intermediate form data flow graph;
merging at least two of the plurality of nodes to form a supernode; and
assigning the supernode to a processor array.

2. The method of claim 1, the processor array comprising a system board, an application specific integrated circuit, a sub-cluster, and an execution processor.

3. The method of claim 2, wherein assigning the supernode is performed level by level within the processor array.

4. The method of claim 1, wherein the supernode is coarser than a member of the plurality of nodes.

5. The method of claim 1, wherein at least two of the plurality of nodes inherit a partition of the supernode.

6. The method of claim 1, merging at least two of the plurality of nodes comprising at least one heuristic selected from the group consisting of heavy edge matching, schedule-based clustering, random matching, critical subset hyperedge coarsening, and functional merging.

7. The method of claim 1, further comprising:
arranging the plurality of nodes within the processor array to minimize a communication cost between a plurality of supernodes.

8. The method of claim 7, further comprising:
visiting each member of the plurality of nodes and each member of the plurality of supernodes in random order and moving the node to a different partition to minimize the communication cost.

9. The method of claim 7, the processor array comprising a system board, an application specific integrated circuit, a sub-cluster, and an execution processor.

10. The method of claim 9, wherein arranging the plurality of nodes balances the communication congestion across the processor array and lowers the distance traveled by a message.

11. The method of claim 1, further comprising:
mapping the plurality of nodes within the supernode to the processor array.

12. The method of claim 11, the processor array comprising a system board, an application specific integrated circuit, a sub-cluster, and an execution processor.

13. A method for partitioning execution processor code in a cycle-based system comprising:
generating an intermediate form data flow graph during compilation of execution processor code;
creating a plurality of nodes from the intermediate form data flow graph;
merging at least two of the plurality of nodes to form a supernode;
assigning the supernode to a processor array;
arranging the plurality of nodes within the processor array to minimize a communication cost between a plurality of supernodes;
visiting each member of the plurality of nodes and each member of the plurality of supernodes in random order and moving the node to a different partition to minimize the communication cost; and
mapping the plurality of nodes within the supernode to the processor array.

14. A computer system to partition execution processor code in a cycle-based system comprising:
a processor;
a memory; and
software instructions stored in the memory for enabling the computer system under control of the processor, to perform:
generating an intermediate form data flow graph during compilation of execution processor code;
creating a plurality of nodes from the intermediate form data flow graph;
merging at least two of the plurality of nodes to form a supernode; and
assigning the supernode to a processor array.

15. The computer system of claim 14, the processor array comprising a system board, an application specific integrated circuit, a sub-cluster, and an execution processor.

16. The computer system of claim 15, wherein assigning the supernode is performed level by level within the processor array.

17. The computer system of claim 14, wherein the supernode is coarser than a member of the plurality of nodes.

18. The computer system of claim 14, wherein at least two of the plurality of nodes inherit a partition of the supernode.

19. The computer system of claim 14, merging at least two of the plurality of nodes comprising at least one heuristic selected from the group consisting of heavy edge matching, schedule-based clustering, random matching, critical subset hyperedge coarsening, and functional merging.

20. A computer system to partition execution processor code in a cycle-based system comprising:
a processor;
a memory; and
software instructions stored in the memory for enabling the computer system under control of the processor, to perform:
generating an intermediate form data flow graph during compilation of execution processor code;
creating a plurality of nodes from the intermediate form data flow graph;
merging at least two of the plurality of nodes to form a supernode;
assigning the supernode to a processor array;
arranging the plurality of nodes within the processor array to minimize a communication cost between a plurality of supernodes; and
mapping the plurality of nodes within the supernode to the processor array.

21. The computer system of claim 20, further comprising:
visiting each member of the plurality of nodes and each member of the plurality of supernodes in random order and moving the node to a different partition to minimize the communication cost.

22. The computer system of claim 20, the processor array comprising a system board, an application specific integrated circuit, a sub-cluster, and an execution processor.

23. The computer system of claim 22, wherein arranging the plurality of nodes balances the communication congestion across the processor array and lowers the distance traveled by a message.

24. An apparatus for partitioning execution processor code in a cycle-based system comprising:
means for generating an intermediate form data flow graph during compilation of execution processor code;
means for creating a plurality of nodes from the intermediate form data flow graph;
means for merging at least two of the plurality of nodes to form a supernode; and
means for assigning the supernode to a processor array.
